(19) United States
(12) Patent Application Publication
(10) Pub. No.: US 2026/0302795 A1
(43) Pub. Date: Oct. 1, 2026

(54) POWER MANAGEMENT SYSTEM AND POWER MANAGEMENT METHOD

(71) Applicant: LITE-ON SINGAPORE PTE. LTD., Singapore (SG)

(72) Inventors: Hongyuan DING, Singapore (SG); Jing YANG, Singapore (SG); Cassandra Yi Chyn WONG, Singapore (SG)

(21) Appl. No.: 19/352,598

(22) Filed: Oct. 8, 2025

Related U.S. Application Data
(60) Provisional application No. 63/777,038, filed on Mar. 25, 2025.

(51) Int. Cl. H02J 3/46; G06Q 50/06; H02J 3/00; H02J 3/32; H02J 3/38; H02J 7/00

(52) U.S. Cl. CPC H02J 3/466; G06Q 50/06; H02J 3/003; H02J 3/004; H02J 3/32; H02J 3/381; H02J 7/82; H02J 7/855; H02J 7/933; H02J 7/971; H02J 2101/24

(57) ABSTRACT

Provided is a power management system including an inverter and a computing device. The inverter is operatively coupled to a photovoltaic array, a power grid, and a battery. The computing device is configured to control the inverter to operate in one of the rule-based control mode and the scheduling mode based on a cost evaluation table, collect measurement data periodically from the inverter, calculate a first future cost corresponding to the rule-based control mode and a second future cost corresponding to the scheduling mode based on the measurement data, and update the cost evaluation table based on the first future cost and the second future cost. The cost evaluation table is configured to store, for each of a plurality of time intervals, a cost value corresponding to each of the operating modes.

### CROSS REFERENCE TO RELATED APPLICATIONS

This application claims the benefit of U.S. Provisional Application No. 63/777,038 filed Mar. 25, 2025, the entirety of which is incorporated by reference herein.

### TECHNICAL FIELD

The present disclosure relates to energy management, and, in particular, to a power management system for hybrid inverters that dynamically selects control modes based on cost evaluation.

### BACKGROUND

In the field of energy management for hybrid inverter applications, control strategies for coordinating photovoltaic (PV) generation, load demand, and battery energy storage systems (BESS) play a critical role in optimizing energy usage and cost efficiency. Two common control strategies include rule-based control (RBC) and scheduling-based control modes, each exhibiting distinct characteristics and trade-offs.

Rule-based control mode performs dynamic adjustments to BESS power in real time based on instantaneous measurements of PV generation, load power, and state-of-charge (SoC) of the battery. By reacting immediately to real-time input data, RBC helps minimize grid interaction and enables configurations such as self-consumption mode, where locally generated renewable energy is prioritized. However, this mode tends to result in frequent battery cycling, which may accelerate battery degradation. Additionally, because it lacks future cost foresight, it may not capture optimal economic outcomes, particularly under variable electricity pricing schemes such as time-of-use tariffs.

In contrast, scheduling-based control mode relies on forecasted PV generation and load profiles, along with electricity tariff data, to compute an optimized charge/discharge schedule for future intervals. The optimization process, which may incorporate model-based algorithms or reinforcement learning techniques, seeks to shift charging to low-tariff periods and discharging to peak-price periods. This leads to smoother battery operation and potentially lower energy costs. Nevertheless, its effectiveness depends heavily on forecast accuracy. If actual conditions deviate significantly from predictions, performance can deteriorate and may become less responsive to real-time fluctuations in power demand or generation.

Since neither of the aforementioned modes offers a universally optimal solution under varying conditions, there is growing interest in combining their strengths. Therefore, it would be desirable to have a power management system capable of adaptively switching between control modes in a manner that minimizes overall energy cost while maintaining operational reliability and responsiveness.

### BRIEF SUMMARY

An embodiment of the present disclosure provides a power management system which includes an inverter and a computing device. The inverter is operatively coupled to a photovoltaic (PV) array, a power grid, and a battery. The inverter is configured to operate in one of multiple operating modes to determine a power setpoint for the battery. The operating modes includes a rule-based control mode and a scheduling mode. The computing device is in communication with the inverter, and is configured to control the inverter to operate in one of the rule-based control mode and the scheduling mode based on a cost evaluation table, collect measurement data periodically from the inverter, calculate a first future cost corresponding to the rule-based control mode and a second future cost corresponding to the scheduling mode based on the measurement data, and update the cost evaluation table based on the first future cost and the second future cost. The cost evaluation table is configured to store, for each of a plurality of time intervals, a cost value corresponding to each of the operating modes.

In an embodiment, the computing device is further configured to retrieve, from the cost evaluation table based on a time interval index derived from a current time value, a first current cost corresponding to the rule-based control mode and a second current cost corresponding to the scheduling mode. The computing device is further configured to compare the first current cost and the second current cost to select one of the rule-based control mode and the scheduling mode as a lower-cost mode. The computing device is further configured to control the inverter to operate in the selected lower-cost mode. The computing device is further configured to update the cost evaluation table by adjusting the first current cost and the second current cost based on the first future cost and the second future cost, respectively.

In an embodiment, the computing device is further configured to control the inverter to operate in the scheduling mode, in response to determining that the second current cost is less than the first current cost. The computing device is further configured to control the inverter to operate in the rule-based control mode, in response to determining that second current cost is not less than the first current cost.

In an embodiment, the computing device is further configured to update the cost evaluation table by replacing the first current cost with a first weighted sum of the first future cost and the first current cost, and replacing the second current cost with a second weighted sum of the second future cost and the second current cost.

In an embodiment, the computing device is further configured to apply a first estimation model corresponding to the rule-based control mode, based on the measurement data at a previous time interval in a past period, to calculate a first estimated cost. For each of subsequent time intervals in the past period, the computing device is further configured to: retrieve, from the cost evaluation table, cost values corresponding to the rule-based control mode and the scheduling mode; select, by comparing the retrieved cost values, one of the rule-based control mode and the scheduling mode as a lower-cost mode for the subsequent time interval; and apply an estimation model corresponding to the selected lower-cost mode, based on the measurement data corresponding to the subsequent time interval, to calculate a first subsequent estimated cost. The computing device is further configured to sum the first estimated cost and the first subsequent estimated costs over the past period to obtain the first future cost. The computing device is further configured to apply a second estimation model corresponding to the scheduling mode, based on the measurement data corresponding to the previous time interval, to calculate a second estimated cost. For each of subsequent time intervals in the past period, the computing device is further configured to: retrieve, from the cost evaluation table, the cost values corresponding to the rule-based control mode and the scheduling mode; select, by comparing the retrieved cost values, one of the rule-based control mode and the scheduling mode as a lower-cost mode for the subsequent time interval; and apply the estimation model corresponding to the selected lower-cost mode, based on the measurement data corresponding to the subsequent time interval, to calculate a second subsequent estimated cost. The computing device is further configured to sum the second estimated cost and the firsts over the past period to obtain the second future cost.

In an embodiment, the measurement data includes power demand, power generation of the PV array, and a State of Charge (SOC) of the battery.

In an embodiment, in response to applying the first estimation model, the computing device is further configured to obtain, through the first estimation model, an estimated battery power corresponding to the previous time interval based on the measurement data corresponding to the previous time interval. The computing device is further configured to calculate the first estimated cost based on a tariff of the power grid, the estimated battery power, and the measurement data, each corresponding to the previous time interval. For each of the subsequent time intervals in the past period, in response to applying the first estimation model, the computing device is further configured to obtain, through the first estimation model, the estimated battery power corresponding to the subsequent time interval based on the measurement data corresponding to the subsequent time interval; and calculate, a subsequent estimated cost based on the tariff of the power grid, the estimated battery power, and the measurement data, each corresponding to the subsequent time interval.

In an embodiment, the computing device is further configured to generate, through a forecast model and based on historical measurement data associated with the power demand and the power generation of the PV array, predicted data associated with the power demand and the power generation of the PV array periodically. The computing device is further configured to obtain, through the second estimation model, an optimized battery power corresponding to the previous time interval based on the predicted data and the SOC of the battery corresponding to the previous time interval. The computing device is further configured to calculate the second estimated cost based on a tariff of the power grid, the optimized battery power, and the measurement data, each corresponding to the previous time interval. For each of the subsequent time intervals in the past period, in response to applying the second estimation model, the computing device is further configured to obtain, through the second estimation model, the optimized battery power corresponding to the subsequent time interval based on the predicted data and the SOC of the battery corresponding to the subsequent time interval; and calculate the subsequent estimated cost based on the tariff of the power grid, the optimized battery power, and the measurement data, each corresponding to the subsequent time interval.

In an embodiment, the inverter is further configured to determine the power setpoint for the battery through an optimization model based on the predicted data, the SOC of the battery, and the tariff, in the scheduling mode. The inverter is further configured to determine the power setpoint for the battery based on the measurement data, in the rule-based control mode.

In an embodiment, the computing device controls the inverter to operate in the rule-based control mode during an initial operating period prior to selection of the operating mode based on the cost evaluation table.

In an embodiment, the power management system further includes an edge device that interfaces between the inverter and the computing device to relay real-time measurement data and control signals, wherein the computing device is a cloud server.

In an embodiment, the inverter is configured to adjust a power flow more frequently in the rule-based control mode than in the scheduling mode.

An embodiment of the present disclosure provides a power management method. The method is executed by a computing device in communication with an inverter. The inverter is operatively coupled to a photovoltaic (PV) array, a power grid, and a battery, and the inverter is configured to operate in one of multiple operating modes to determine a power setpoint for the battery. The operating modes includes a rule-based control mode and a scheduling mode. The method includes controlling the inverter to operate in one of the rule-based control mode and the scheduling mode based on a cost evaluation table. The cost evaluation table is configured to store, for each of a plurality of time intervals, a cost value corresponding to each of the operating modes. The method further includes collecting measurement data periodically from the inverter. The method further includes calculating a first future cost corresponding to the rule-based control mode and a second future cost corresponding to the scheduling mode based on the measurement data. The method further includes updating the cost evaluation table based on the first future cost and the second future cost.

In an embodiment, the method further includes retrieving, from the cost evaluation table based on a time interval index derived from a current time value, a first current cost corresponding to the rule-based control mode and a second current cost corresponding to the scheduling mode. The method further includes comparing the first current cost and the second current cost to select one of the rule-based control mode and the scheduling mode as a lower-cost mode. The method further includes controlling the inverter to operate in the selected lower-cost mode. The method further includes updating the cost evaluation table by adjusting the first current cost and the second current cost based on the first future cost and the second future cost, respectively.

In an embodiment, the method further includes controlling the inverter to operate in the scheduling mode, in response to determining that the second current cost is less than the first current cost. The method further includes controlling the inverter to operate in the rule-based control mode, in response to determining that second current cost is not less than the first current cost.

In an embodiment, the method further includes updating the cost evaluation table by replacing the first current cost with a first weighted sum of the first future cost and the first current cost, and replacing the second current cost with a second weighted sum of the second future cost and the second current cost.

In an embodiment, the method further includes applying a first estimation model corresponding to the rule-based control mode, based on the measurement data at a previous time interval in a past period, to calculate a first estimated cost at the previous time interval. For each of subsequent time intervals in the past periods, the method further includes: retrieving, from the cost evaluation table, cost values corresponding to the rule-based control mode and the scheduling mode; selecting, by comparing the retrieved cost values, one of the rule-based control mode and the scheduling mode as a lower-cost mode for the subsequent time interval; and applying an estimation model corresponding to the selected lower-cost mode, based on the measurement data corresponding to the subsequent time interval, to calculate a first subsequent estimated cost. The method further includes summing the first estimated cost and the first subsequent estimated costs over the past period to obtain the first future cost. The method further includes applying a second estimation model corresponding to the scheduling mode, based on the measurement data corresponding to the previous time interval, to calculate a second estimated cost. For each of the subsequent time intervals in the past period, the method further includes: retrieving, from the cost evaluation table, the cost values corresponding to the rule-based control mode and the scheduling mode; selecting, by comparing the retrieved cost values, one of the rule-based control mode and the scheduling mode as a lower-cost mode for the subsequent time interval; and applying the estimation model corresponding to the selected lower-cost mode, based on the measurement data corresponding to the subsequent time interval, to calculate a second subsequent estimated cost. The method further includes summing the second estimated cost and the second subsequent estimated costs over the past period to obtain the second future cost.

In an embodiment, in response to applying the first estimation model, the method further includes obtaining, through the first estimation model, an estimated battery power corresponding to the previous time interval based on the measurement data corresponding to the previous time interval; and calculating the first estimated cost based on a tariff of the power grid, the estimated battery power, and the measurement data, each corresponding to the previous time interval. For each of the subsequent time intervals in the past period, in response to applying the first estimation model, the method further includes obtaining, through the first estimation model, the estimated battery power corresponding to the subsequent time interval based on the measurement data corresponding to the subsequent time interval; and calculating, a subsequent estimated cost based on the tariff of the power grid, the estimated battery power, and the measurement data, each corresponding to the subsequent time interval.

In an embodiment, the method further includes generating, through a forecast model and based on historical measurement data associated with the power demand and the power generation of the PV array, predicted data associated with the power demand and the power generation of the PV array periodically. The method further includes obtaining, through the second estimation model, the estimated battery power corresponding to the previous time interval based on the predicted data and the SOC of the battery corresponding to the previous time interval. The method further includes calculating the second estimated cost based on a tariff of the power grid, the estimated battery power, and the measurement data, each corresponding to the previous time interval. For each of the subsequent time intervals in the past period, in response to applying the second estimation model, the method further includes obtaining, through the second estimation model, the estimated battery power corresponding to the subsequent time interval based on the predicted data and the SOC of the battery corresponding to the subsequent time interval; and calculating the subsequent estimated cost based on the tariff of the power grid, the optimized battery power, and the measurement data, each corresponding to the subsequent time interval.

The power management system and method proposed herein provide an adaptive control framework that intelligently switches between a rule-based control mode and a scheduling mode based on a learned cost evaluation table. By leveraging real-time measurement data, forecasted demand and generation, and mode-specific estimation models, the disclosed system dynamically minimizes energy costs while maintaining operational flexibility. This hybrid control strategy not only enhances the efficiency and responsiveness of photovoltaic and energy storage integration, but also offers scalability for deployment in diverse energy management scenarios.

### BRIEF DESCRIPTION OF THE DRAWINGS

The present disclosure can be more fully understood by reading the subsequent detailed description and examples with references made to the accompanying drawings, wherein:

FIG. 1 illustrates a schematic diagram of a power management system, according to a present disclosure;

FIG. 2 illustrates a system block diagram of the computing device, according to an embodiment of the present disclosure;

FIG. 3 is a flow diagram illustrating further steps of controlling the inverter to operate in one of the rule-based control mode and the scheduling mode, according to an embodiment of the present disclosure;

FIG. 4 is the flow diagram a flow diagram illustrating further steps of the calculation of the first future cost and second future cost, according to an embodiment of the present disclosure;

FIG. 5A is a schematic diagram illustrating the process of applying a first estimation model to compute the first estimated cost, according to an embodiment of the present disclosure;

FIG. 5B illustrates, according to an embodiment of the present disclosure, a process of calculating a subsequent estimated cost when the rule-based control mode is selected as the lower-cost mode for a subsequent time interval in the past period;

FIG. 6A is a schematic diagram illustrating the process of applying a second estimation model to compute the first estimated cost, according to an embodiment of the present disclosure;

FIG. 6B illustrates, according to an embodiment of the present disclosure, a process of calculating a subsequent estimated cost when the scheduling mode is selected as the lower-cost mode for a subsequent time interval in the past period; and

FIG. 7 is a flow diagram illustrating the overall process of dynamic mode selection, according to an embodiment of the present disclosure.

### DETAILED DESCRIPTION

The following description is made for the purpose of illustrating the general principles of the invention and should not be taken in a limiting sense. The scope of the invention is best determined by reference to the appended claims.

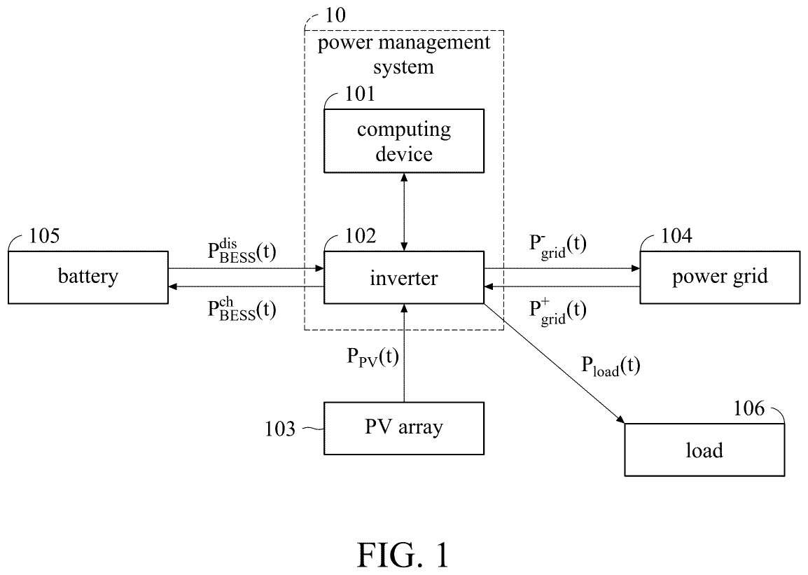

FIG. 1 illustrates a schematic diagram of a power management system 10, according to a present disclosure. As shown in FIG. 1, the power management system 10 includes a computing device 101 and an inverter 102. The computing device 101 is in communication with the inverter 102. The inverter 102 is operatively coupled to a photovoltaic (PV) array 103, a power grid 104, and a battery 105. In addition, a load 106 is supplied with electricity under control of the inverter 102.

The computing device 101 may include a processor, a memory, and one or more input/output interfaces configured to execute software instructions for managing operation of the inverter 102. Specifically, the memory stores computer-readable instructions, and the processor is configured to execute the instructions to perform functions associated with the power management system 10. The computing device 101 may be implemented as an embedded controller, an industrial PC, a microcontroller-based unit, or a system-on-chip. In some embodiments, the computing device 101 may be deployed at the edge of the system, for example, integrated with the inverter 102 or installed locally within the power management infrastructure. Alternatively, the computing device 101 may be implemented as a remote server connected to the inverter 102 via a communication network.

The inverter 102 is configured to regulate power flow among the battery 105, the PV array 103, the power grid 104, and the load 106. In particular, the inverter 102 is capable of performing DC/AC or AC/DC power conversion, and controlling power distribution paths to ensure efficient energy usage and stability of the system.

The PV array 103 is configured to convert solar energy into electric power, which is supplied to the inverter 102. The power grid 104 may serve as an external power source and a sink, allowing the inverter 102 to either import electricity from or export electricity to the utility grid. The battery 105 is configured to store electrical energy and may supply or absorb power depending on the control strategy. The load 106 represents electrical appliances or systems that consume electricity. The inverter 102 regulates the power flow among the PV array 103, the battery 105, the power grid 104, and the load 106.

In particular, the inverter 102 manages bidirectional power exchange with the battery 105. The symbol

$${P}_{BESS}^{dis} ( t )$$

denotes the discharging power from the battery 105 to the inverter 102 at time t, and

$${P}_{BESS}^{ch} ( t )$$

denotes the charging power from the inverter 102 to the battery 105 at time t. The time parameter t represents a discrete time index within a power control cycle or interval. The inverter 102 may determine, at each time interval t, whether to charge or discharge the battery based on system conditions and control objectives.

The inverter 102 also manages power flows with the PV array 103 and the power grid 104. The symbol P_{PV}(t) denotes the electric power generated by the PV array 103 at time t. The power exchanged between the inverter 102 and the power grid 104 includes two directions. The symbol

$${P}_{grid}^{+} ( t )$$

represents the power imported from the power grid 104 to the inverter 102 at time t, while the symbol

$${P}_{grid}^{-} ( t )$$

represents the power exported from the inverter 102 to the power grid 104 at time t. The symbol P_{load}(t) denotes the electric power consumed by the load 106 at time t. The inverter 102 coordinates and balances the power between generation, storage, grid interaction, and consumption dynamically and in real time based on system measurements and control logic.

The inverter 102 is configured to operate in one of multiple operating modes to determine a power setpoint for the battery. The power setpoint refers to a target charge or discharge power level to be delivered to or absorbed from the battery 105 at a given time t. Based on this power setpoint, the inverter 102 regulates the charging power

$${P}_{BESS}^{ch} ( t )$$

or discharging power

$${P}_{BESS}^{dis} ( t )$$

so as to coordinate the battery operation with other energy sources and loads in the system. The determination of the power setpoint directly influences energy cost, battery lifetime, and interaction with the power grid.

One commonly used operating mode is the rule-based control mode. In this mode, the inverter 102 determines the battery power setpoint dynamically based on real-time measurements, including photovoltaic (PV) power P_{PV}(t), load demand P_{load}(t), and the battery's state of charge (SoC). Specifically, a net demand value D(t)=P_{load}(t)−P_{PV}(t) is computed. If the load exceeds PV generation (i.e., D(t)>0), the battery may be discharged to supply the difference. Conversely, if there is surplus PV generation (i.e., D(t)<0), the battery may be charged to absorb the excess energy. The desired Battery Energy Storage System (BESS) power \hat{P}_{BESS}(t) is initially set as −D(t), and is then clamped within the feasible range defined by the battery's power constraints and SoC limits. The inverter applies this feasible power to the battery 105, while any remaining net demand or surplus is either imported from or exported to the power grid 104, represented by

$${P}_{grid}^{+} ( t ) and {P}_{grid}^{-} ( t ) ,$$

respectively. This mode enables real-time response and is simple to implement, but may result in frequent battery cycling and suboptimal cost performance.

Another commonly used operating mode is the scheduling mode, which utilizes forecast data and optimization techniques to generate a planned charging/discharging profile over a future horizon of time steps. In this mode, the inverter 102 cooperates with the computing device 101 to process forecasted PV generation P_{PV}(t), forecasted load demand P_{load}(t), and electricity pricing data, such as buying and selling tariffs. An optimization or reinforcement learning algorithm is applied to determine a set of power setpoints

$${P}_{BESS}^{ch} ( t ) and {P}_{BESS}^{dis} ( t )$$

that minimize the expected energy cost over the planning horizon, subject to power balance and battery constraints. The resulting setpoints may be applied in a receding horizon fashion, and provide smoother battery operation with the potential for lower energy costs, although at the expense of reduced responsiveness to real-time fluctuations.

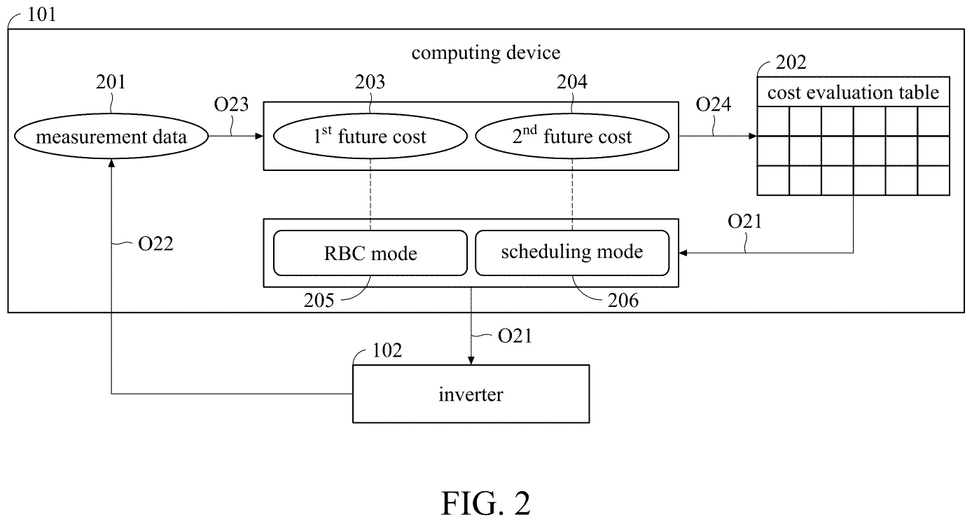

FIG. 2 illustrates a system block diagram of the computing device 101, according to an embodiment of the present disclosure. As shown in FIG. 2, the computing device 101 is configured to implement a power management method, which involves operations O21-O24. Each of these operations will be elaborated below.

Operation O21 involves controlling the inverter 102 to operate in one of the rule-based control mode and the scheduling mode based on a cost evaluation table 202. The cost evaluation table 202 is configured to store, for each of a plurality of time intervals, a cost value corresponding to each of the operating modes.

In one example implementation, <Table 1> below illustrates how cost values may be stored and indexed by time and operating mode.

TABLE 1

| Time of Day | | 0 | 1 | 2 | . . . | N − 1 |
|---|---|---|---|---|---|---|
| Action | 0 (RBC) | Q(0, 0) | Q(0, 1) | Q(0, 2) | . . . | Q(0, |
| (Mode) | | | | | | N − 1) |
| σ (t) = α | 1 | Q(1, 0) | Q(1, 1) | Q(1, 2) | . . . | Q(1, |
| | (Scheduling) | | | | | N − 1) |

As shown in <Table 1>, each column corresponds to a time index within a scheduling horizon (e.g., indexed from 0 to N−1), and each row represents a candidate operating mode, such as mode 0 for the rule-based control mode and mode 1 for the scheduling mode. The entry Q(a, n) denotes a cost value corresponding to selecting operating mode a∈{0,1} at time index n. The computing device 101 is configured to select an optimal operating mode for each time interval based on a comparison of the corresponding cost values, thereby forming a mode sequence σ(t)=a over the operation horizon. In one example, if measurement data 201 is collected every 30 minutes, there will be 48 time intervals in one day, and thus N will be equal to 48. The structure of the cost evaluation table 202 allows for efficient lookup and update of mode-dependent cost profiles, supporting both online evaluation and learning-based adaptation.

Operation O22 involves collecting measurement data 201 periodically from the inverter 102. The measurement data 201 may include, for example, real-time power output P_{PV}(t) from the PV array 103, power consumption P_{load}(t) of the load 106, SoC data of the battery 105, charging power

$${P}_{BESS}^{ch} ( t )$$

and discharging power

$${P}_{BESS}^{dis} ( t )$$

of the battery 105, and grid import/export power

$${P}_{grid}^{+} ( t ) , {P}_{grid}^{-} ( t ) .$$

This information may be stored in the computing device 101 and used as input for subsequent cost estimation processes.

Operation O23 involves calculating a first future cost 203 corresponding to the rule-based control mode 205 and a second future cost 204 corresponding to the scheduling mode 206 based on the measurement data 201. The term “future cost” herein refers to a cumulative cost value computed over a future optimization horizon under the assumption that the system initially selects one of the operating modes at a given time step. While the first action is fixed to the selected mode, subsequent actions within the horizon are assumed to follow an optimal policy determined according to the cost evaluation table. Therefore, the future cost reflects the hypothetical total cost that would result if the selected mode were taken at the current time step, followed by dynamically selecting the optimal mode at each following time step. The purpose of this computation is not to forecast actual energy expenses, but rather to enable cost-based mode comparison for decision making.

Operation O24 involves updating the cost evaluation table 202 based on the first future cost 203 and the second future cost 204. In particular, the entries Q(0,n) and Q(1,n) may be respectively updated to reflect the most recently computed first and second future cost values for each future time index n. The purpose of updating the cost evaluation table 202 is to maintain an up-to-date reference that reflects current or forecasted system conditions, thus enabling adaptive and informed mode selection at each time step. This update process allows the computing device 101 to progressively refine its mode-switching policy in response to changing operating environments.

Although not shown in FIG. 1 or FIG. 2, in an embodiment where the computing device 101 is implemented as a cloud server, an edge device may be further included in the power management system 10 to serve as an intermediary interface between the inverter 102 and the cloud server. The edge device may be configured to locally collect real-time measurement data, such as voltage, current, power, and State of Charge (SOC), from various system components including the PV array 103, the battery 105, and the load 106. The edge device may also be configured to pre-process, buffer, or compress such data before transmitting it to the cloud server over a network, thereby reducing communication latency and bandwidth consumption.

In addition to data acquisition and transmission, the edge device may also receive control instructions or operational parameters generated by the cloud server based on higher-level optimization algorithms, and forward such instructions to the inverter 102 in a timely manner. In some embodiments, the edge device may be further equipped with limited computing capabilities to execute fallback control logic or to temporarily assume local control functions in the event of communication loss with the cloud server. Accordingly, the inclusion of the edge device enhances system robustness, scalability, and responsiveness, particularly in distributed energy systems where remote cloud-based computation is employed.

In an embodiment, the inverter 102 is configured to adjust the power flow more frequently in the rule-based control mode 205 than in the scheduling mode 206. In particular, in the rule-based control mode 205, the inverter 102 may update its power setpoint at relatively short time intervals, such as every few seconds or minutes, based on real-time measurement data including instantaneous power demand, PV generation, and battery SOC. This allows the system to promptly respond to rapid fluctuations in load or generation, thereby maintaining operational stability and avoiding overcharging or over-discharging of the battery.

By contrast, in the scheduling mode 206, the inverter 102 may be configured to follow a predetermined or optimized power dispatch plan over a longer control interval, such as 15 minutes or 30 minutes, thereby reducing switching frequency and associated control overhead. The lower frequency of adjustment in the scheduling mode reflects the reliance on forecasted data and planned energy dispatch, which are less sensitive to short-term variations. This distinction in control frequency between the two modes enables the power management system to balance responsiveness and computational efficiency, while leveraging the strengths of both real-time rule-based control and forward-looking scheduling strategies.

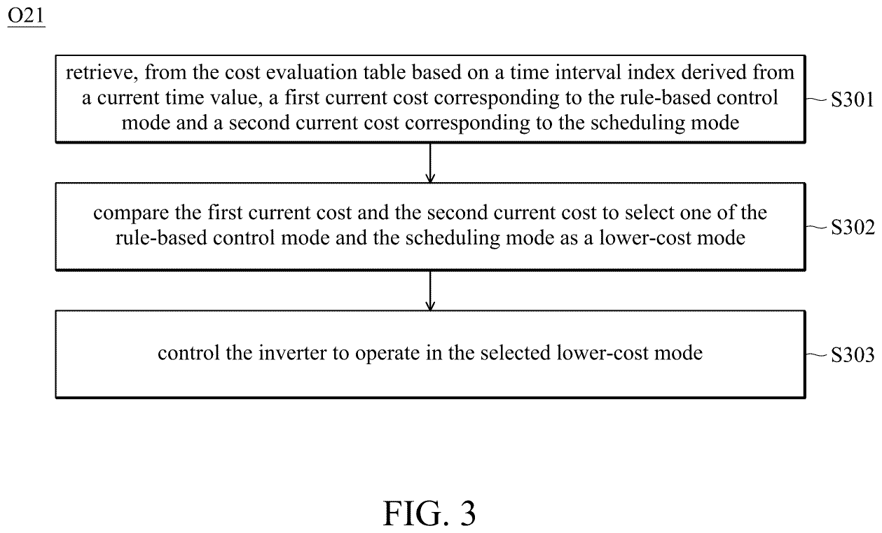

FIG. 3 is a flow diagram illustrating further steps of controlling the inverter 102 to operate in one of the rule-based control mode and the scheduling mode in the operation O21, according to an embodiment of the present disclosure. As shown in FIG. 3, the operation O21 may further include steps S301-S303. Each of these steps will be elaborated below.

In step S301, the computing device 101 retrieves, from the cost evaluation table 202, a first current cost and a second current cost respectively corresponding to the rule-based control mode and the scheduling mode. The retrieval is based on a time interval index derived from a current time value, for example by applying a modulo operation such as mod(t, N) to the current time step t, where N denotes the number of time intervals in one day. This indexing approach allows the cost evaluation table 202 to maintain a cyclical representation of cost values over recurring daily intervals, thereby enabling adaptive mode selection based on the time of day.

In step S302, the computing device 101 compares the first current cost and the second current cost retrieved from the cost evaluation table 202. Based on this comparison, the computing device 101 selects the operating mode corresponding to the lower of the two cost values. That is, if the cost corresponding to the rule-based control mode is lower than that of the scheduling mode, the system selects the rule-based control mode for that time interval, and vice versa. This decision-making process allows the system to dynamically adapt its operating mode in response to time-dependent cost trends.

In step S303, the computing device 101 controls the inverter 102 to operate in the selected lower-cost mode. In an embodiment where the operating modes of the inverter 102 merely include the rule-based control mode and the scheduling mode, in response to determining that the second current cost is less than the first current cost in step S302, the computing device 101 controls the inverter 102 to operate in the scheduling mode in step S303. On the contrary, in response to determining that second current cost is not less than the first current cost in step S302, the computing device 101 controls the inverter 102 to operate in the rule-based control mode in step S303.

In one example implementation, <Table 2> below illustrates exemplary entries in the cost evaluation table 202. The cost values are indexed by time of day, with each column representing a specific time interval, and each row corresponding to a different operating mode.

TABLE 2

| Time of Day | | 0 | 1 | 2 | . . . | N − 1 |
|---|---|---|---|---|---|---|
| Action | 0 (RBC) | 1.0 | 2.0 | 2.4 | . . . | 1.7 |
| (Mode) | 1 (Scheduling) | 1.5 | 1.3 | 1.3 | . . . | 3.1 |
| σ (t) = α | | | | | | |

Referring to FIG. 3 and <Table 2>, an example scenario is illustrated wherein the current time step t corresponds to time interval 2, i.e., mod(t, N)=2. At this index, the first current cost (corresponding to the RBC mode) is 2.4 and the second current cost (corresponding to the scheduling mode) is 1.3. Based on the comparison, since the second current cost is lower, the computing device 101 selects the scheduling mode as the lower-cost mode for that time step. As a result, the inverter 102 is controlled to operate under the scheduling mode.

In this example, the mode selection at each time step t can be mathematically expressed as:

$${σ}^{*} ( t ) = \{ \begin{matrix}1 & if Q ( 0 , mod ( t , N ) ) \geq Q ( 1 , mod ( t , N ) ) \\ 0 & if Q ( 0 , mod ( t , N ) ) < Q ( 1 , mod ( t , N ) )\end{matrix}$$

where σ*(t) denotes the selected mode at time step t, and Q(a, mod(t, N)) represents the cost value corresponding to action a∈{0,1} (i.e., rule-based control mode or scheduling mode) retrieved from the cost evaluation table for the time interval indexed by mod(t, N). The computing device 101 determines the optimal mode by selecting the action with the lower cost, thereby enabling time-adaptive and cost-efficient control.

Subsequent to the execution of step S303, the cost evaluation table 202 is updated by adjusting the first current cost and the second current cost based on the first future cost and the second future cost, respectively. This update mechanism allows the system to incorporate more recent information into the cost evaluation table, thereby improving the accuracy of future mode selections.

In an embodiment, the cost evaluation table 202 is updated by replacing the first current cost with a first weighted sum of the first future cost and the first current cost, and replacing the second current cost with a second weighted sum of the second future cost and the second current cost. The updated cost value for a given action a∈{0,1} and time interval index mod(tᵤ+i, N) may be mathematically expressed as:

$${Q}^{new} ( a , mod ( {t}_{u} + i , N ) ) = ( 1 - α ) \times {Q}^{old} ( a , mod ( {t}_{u} + i , N ) ) + α \times G ( a , {t}_{u} )$$

where α is a learning rate coefficient that determines the weighting between the previous cost value Q^{old} and the newly calculated future cost G(a, tᵤ). This update rule enables the cost evaluation table 202 to be refined iteratively based on historical performance, balancing stability and responsiveness to environmental changes.

It is noted that the update of the cost evaluation table 202 is performed not based on the current time t, but rather on a previous time interval tᵤ, which is defined as tᵤ=t−Hᵤ, where Hᵤ is referred to as an update delay horizon. This update delay horizon is introduced to allow sufficient time for collecting the necessary historical data (e.g., PV generation, load consumption, and battery SoC) over a look-ahead period before the corresponding cost values can be accurately evaluated and used to update the table. Accordingly, at time t, the system targets the Q-values associated with time tᵤ in the cost evaluation table 202 for update.

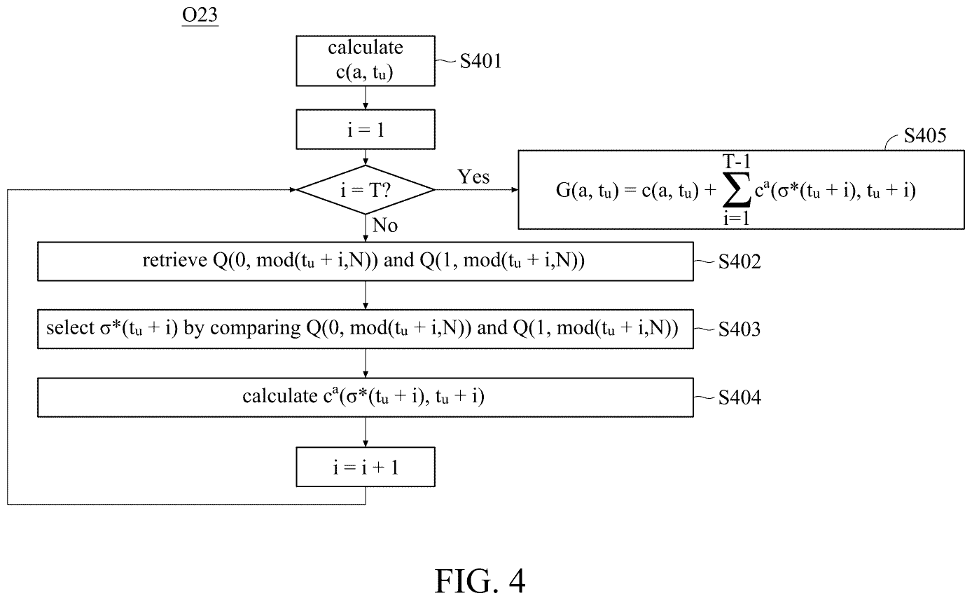

FIG. 4 is a flow diagram illustrating further steps of the calculation of the first future cost 203 and second future cost 204 in operation O23, according to an embodiment of the present disclosure. As shown in FIG. 4, the operation O21 may further include steps S401-S405. Each of these steps will be elaborated below.

In step S401, the computing device 101 applies an estimation model corresponding to the rule-based control mode or a second estimation model corresponding to the scheduling mode to calculate an estimated cost for a previous time interval tᵤ in a past period. Specifically, when computing the first future cost 203, the first estimation model is applied to historical measurement data corresponding to ty to calculate a first estimated cost c(0, tᵤ). Similarly, when computing the second future cost 204, the second estimation model is applied to calculate a second estimated cost c(1, tᵤ).

Steps S402 through S404 involve iterating over each of a plurality of subsequent time intervals in the past period to calculate the respective subsequent estimated costs. In step S402, the computing device 101 retrieves, from the cost evaluation table 202, the cost values Q(0, mod(tᵤ+i, N) and Q(1, mod(tᵤ+i, N) respectively corresponding to the rule-based control mode and the scheduling mode at a time index corresponding to the subsequent interval tᵤ+i, where i∈{1, . . . , T−1}. T is the optimization rolling horizon, the period over which the energy cost is optimized. For example, if T=48 and the measurement data 201 is collected every 30 minutes, the cost for the next 24 hours is optimized.

In step S403, the computing device 101 compares the retrieved cost values Q(0, mod(tᵤ+i, N) and Q(1, mod(tᵤ+i, N) to determine a lower-cost mode σ*(tᵤ+i) for each respective subsequent interval. The lower-cost mode is selected dynamically based on the stored costs, and is not necessarily the same as the original mode a that is used to start the cost evaluation in step S401.

In step S404, the computing device 101 applies the estimation model corresponding to the selected lower-cost mode to calculate a subsequent estimated cost, c^{a}(σ*(tᵤ+i), tᵤ+i), where a∈{0,1} corresponds to the initiating mode. The estimation model may be either the first estimation model associated with the rule-based control mode or the second estimation model associated with the scheduling mode. These models take the actual historical measurement data at time tᵤ+i as input to compute the estimated energy cost. Specifically, when computing the first future cost 203 corresponding to the rule-based control mode 205, the computing device 101 calculates a first subsequent estimated cost c⁰(σ*(tᵤ+i), tᵤ+i) at each subsequent time interval tᵤ+i using the estimation model corresponding to the selected lower-cost mode σ*(tᵤ+i). Similarly, when computing the second future cost 204 corresponding to the scheduling mode 206, the computing device 101 calculates a second subsequent estimated cost c¹(σ*(tᵤ+i), tᵤ+i) at each time interval tᵤ+i also using the estimation model corresponding to the selected lower-cost mode. Each of these subsequent estimated costs reflects the dynamic impact of the selected operating mode under historical conditions.

In step S405, the computing device 101 aggregates the estimated costs over the past period. That is, the computing device 101 sums the estimated cost at the first interval with the subsequent estimated costs to compute the complete future cost. In the case of the first future cost 203, the result is given by:

$$G ( 0 , {t}_{u} ) = c ( 0 , {t}_{u} ) + {\sum }_{i = 1}^{T - 1} {c}^{0} ( {σ}^{*} ( {t}_{u} + i ) , {t}_{u} + i )$$

Likewise, for the second future cost 204, the computation is:

$$G ( 1 , {t}_{u} ) = c ( 1 , {t}_{u} ) + {\sum }_{i = 1}^{T - 1} {c}^{1} ( {σ}^{*} ( {t}_{u} + i ) , {t}_{u} + i )$$

Each of these future cost values reflects the total energy cost assuming that the rule-based or scheduling mode is selected at the initial interval, while allowing mode switching thereafter based on the current cost evaluation table.

In an embodiment, the measurement data 201 includes power demand, power generation of the PV array, and a State of Charge (SOC) of the battery. These data items respectively reflect the energy consumption behavior of the load, the available renewable power from the PV array, and the current energy capacity status of the battery. Such measurement data serve as essential inputs for the cost estimation processes, enabling the computing device 101 to assess battery dispatch feasibility and evaluate cost performance under different operating modes.

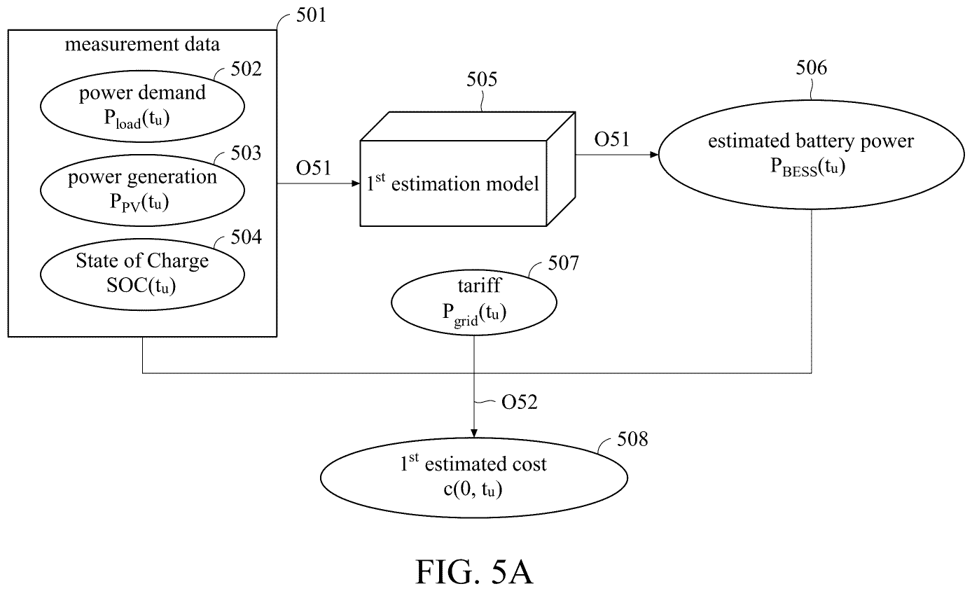

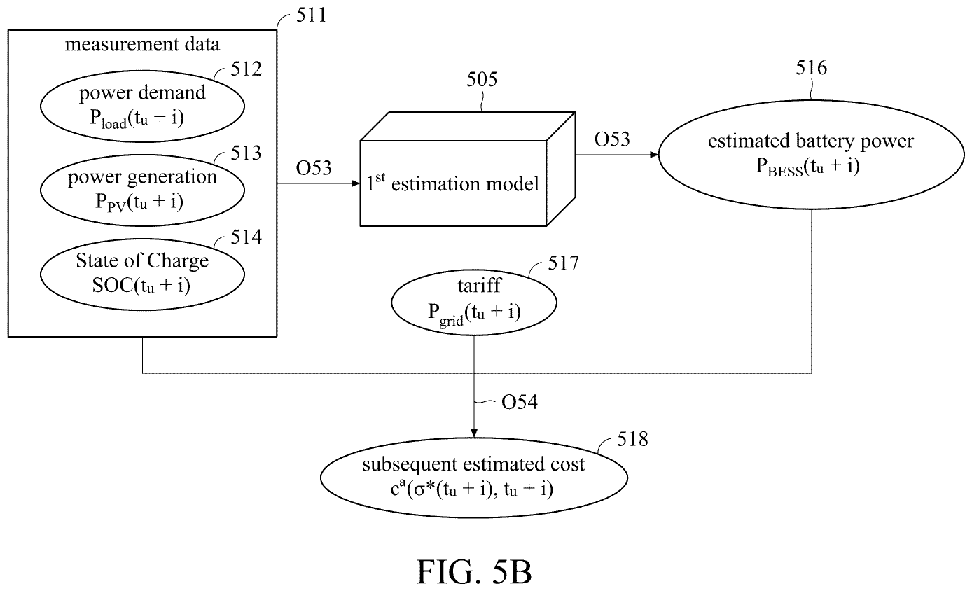

FIG. 5A is a schematic diagram illustrating the process of applying a first estimation model 505 to compute the first estimated cost, according to an embodiment of the present disclosure. As shown in FIG. 5A, operation O51 involves applying the first estimation model 505 to obtain an estimated battery power 506 corresponding to the previous time interval ty. Specifically, the first estimation model 505 receives, as inputs, measurement data 501, which may include the power demand 502 (denoted by P_{load}(tᵤ)), the power generation 503 (denoted by P_{PV}(tᵤ)), and the State of Charge (SOC) 504 of the battery (denoted by SOC(tᵤ)) corresponding to the previous time interval tᵤ. Based on these inputs, the first estimation model 505 generates a corresponding estimated battery power P_{BESS}(tᵤ). The first estimation model 505 may be implemented using a rule-based decision logic, a simulation-based emulator of inverter behavior, or a lightweight machine learning model trained on historical control actions, but the present disclosure is not limited thereto.

Operation O52 involves calculating the first estimated cost 508 (denoted by c(0, tᵤ)) based on the estimated battery power 506 obtained from operation O51, the grid tariff 507 (denoted by P_{grid}(tᵤ)), and the measurement data 501 corresponding to the previous time interval ty. The grid tariff 507 represents the unit price of electricity corresponding to the previous time interval tᵤ and may reflect a dynamic pricing structure adopted by the power grid operator, such as time-of-use rates or real-time market prices.

FIG. 5B illustrates, according to an embodiment of the present disclosure, a process of calculating a subsequent estimated cost when the rule-based control mode is selected as the lower-cost mode for a subsequent time interval in the past period. As shown in FIG. 5B, measurement data 511 corresponding to the time interval tᵤ+i includes the power demand 512 (denoted by P_{load}(tᵤ+i)), the power generation (denoted by P_{PV}(tᵤ+i)), and State of Charge 514 (denoted by SOC(tᵤ+i)). These data are provided as inputs to the first estimation model 505 in operation O53. Based on the input data, the first estimation model 505 outputs an estimated battery power 516 (denoted by P_{BESS}(tᵤ+i)).

In operation O54, the estimated battery power 516, together with the corresponding measurement data and the grid tariff 517 (denoted by P_{grid}(tᵤ+i)), is used to compute a subsequent estimated cost 518. This subsequent estimated cost 518 reflects the expected cost when the inverter is operated under the rule-based control mode at time tᵤ+i.

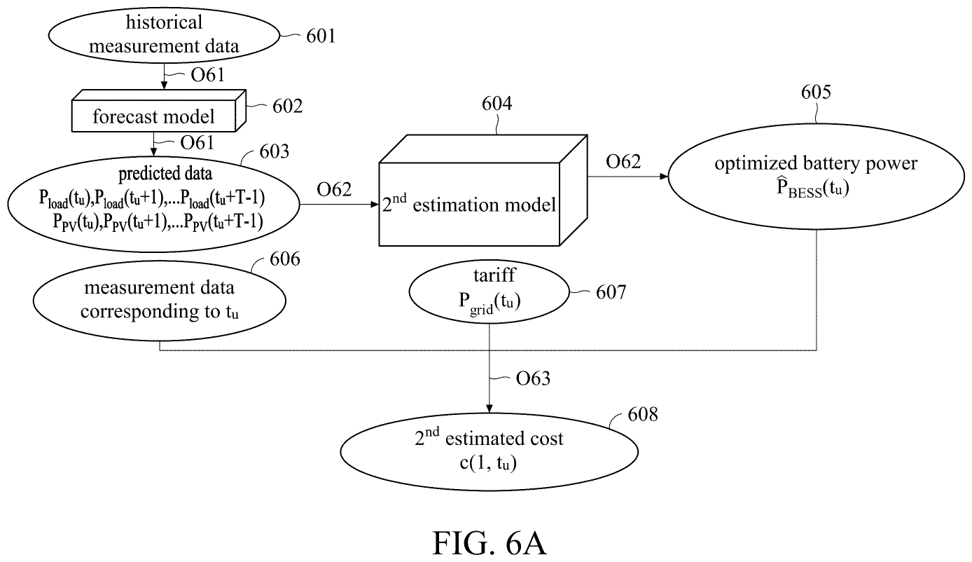

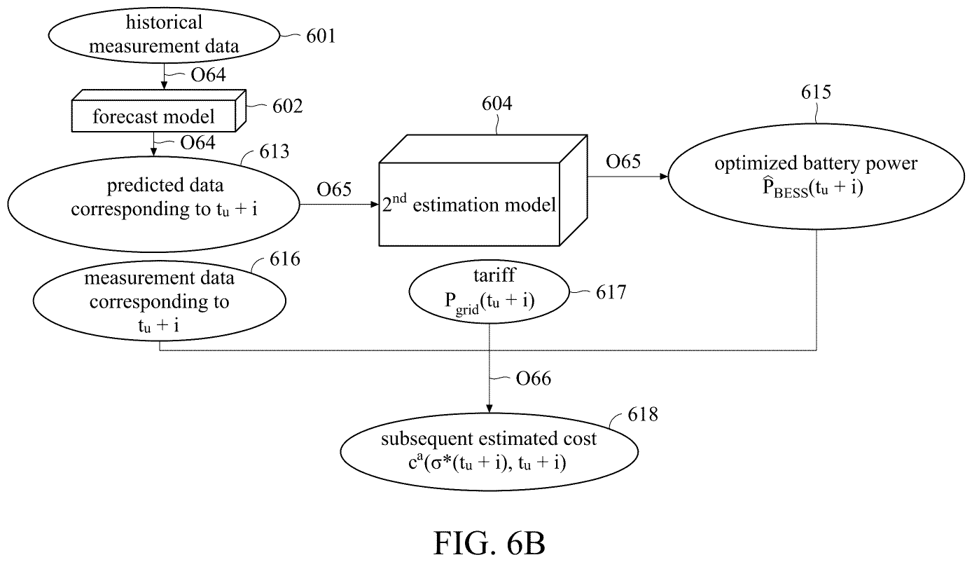

It is noted that FIG. 5B illustrates only the case in which the selected lower-cost mode σ*(tᵤ+i) is the rule-based control mode. For time intervals where the scheduling mode is instead selected as the lower-cost mode, a second estimation model will be applied, as will be described with reference to FIG. 6A and FIG. 6B.

FIG. 6A is a schematic diagram illustrating the process of applying a second estimation model 604 to compute the second estimated cost, according to an embodiment of the present disclosure. In this embodiment, historical measurement data 601, which includes previously observed power demand and PV array generation data, is provided to a forecast model 602 in operation O61. The forecast model 602 is configured to periodically generate predicted data 603 associated with the power demand and the power generation of the PV array over the period from tᵤ to tᵤ+T−1. The forecast model 602 may be implemented using a statistical forecasting technique such as an Autoregressive Integrated Moving Average (ARIMA) model, a neural network model such as Long Short-Term Memory (LSTM), or other machine learning-based time series predictors, but the present disclosure is not limited thereto.

In operation O62, the predicted data 603, together with the actual state of charge of the battery corresponding to the previous time interval tᵤ, i.e., SOC (tᵤ), is provided as input to a second estimation model 604. The second estimation model 604 may be implemented using optimization-based control algorithms, such as model predictive control (MPC), mixed-integer programming (MIP), or enhanced heuristics, but the present disclosure is not limited thereto. The output of the second estimation model 604 is an optimized battery power 605 (denoted by \hat{P}_{BESS}(tᵤ)) corresponding to the previous time interval tᵤ.

In operation O63, the second estimated cost 608, denoted by c(1, tᵤ), is calculated based on the optimized battery power 605, the actual measurement data 606, and the grid tariff 607 (denoted by P_{grid}(tᵤ)), each corresponding to the previous time interval tᵤ. This second estimated cost 608 represents the expected cost that would have occurred at the beginning of the past period if the scheduling mode had been applied.

FIG. 6B illustrates, according to an embodiment of the present disclosure, a process of calculating a subsequent estimated cost when the scheduling mode is selected as the lower-cost mode for a subsequent time interval in the past period. As shown in FIG. 6B, the historical measurement data 601 is used as input to the forecast model 602 in operation O64. The forecast model 602 generates predicted data 613 corresponding to the subsequent time interval tᵤ+i, including anticipated power demand and PV array output.

In operation O65, the predicted data 613, together with the actual state of charge of the battery corresponding to the subsequent time interval tᵤ+i, i.e., SOC(tᵤ+i), is fed into the second estimation model 604 to generate the optimized battery power 615 (denoted by \hat{P}_{BESS}(tᵤ+i) corresponding to the subsequent time interval tᵤ+i.

In operation O66, a subsequent estimated cost 618 is calculated based on the grid tariff 617 (denoted by P_{grid}(tᵤ+i)), the optimized battery power 615, and the measurement data 616, each corresponding to the subsequent time interval tᵤ+i. This subsequent estimated cost 618 represents the expected cost if the scheduling mode were applied at that particular time interval tᵤ+i.

In an embodiment, the inverter 102 is configured to determine a power setpoint for the battery based on different strategies depending on the selected operating mode. In the scheduling mode, the power setpoint is determined through an optimization model that takes as input the predicted data (e.g., predicted power demand and PV generation), the State of Charge (SOC) of the battery, and the grid tariff. The optimization model may be implemented using techniques such as linear programming, quadratic programming, or model predictive control (MPC), to minimize expected operating cost over a future horizon while satisfying system constraints, but the present disclosure is not limited thereto. The optimization output provides an optimal battery power dispatch plan at each time interval within the scheduling window.

In contrast, when operating in the rule-based control mode, the inverter 102 determines the power setpoint for the battery based solely on measurement data acquired in real time. Such measurement data may include the instantaneous power demand, PV generation, and SOC of the battery. The rule-based logic may be implemented using threshold-based decision rules, such as charging the battery when PV generation exceeds demand and SOC is below a certain threshold, or discharging when demand exceeds PV generation and SOC is above another threshold.

In an embodiment, the inverter 102 is controlled by the computing device 101 to operate in the rule-based control mode 205 during an initial operating period, referred to as a warm-up phase, prior to enabling selection of the operating mode based on the cost evaluation table 202. During this warm-up phase, the system accumulates measurement data and generates initial cost estimates for different time intervals without actively switching control modes. Since the cost evaluation table 202 has not yet been sufficiently populated with reliable cost data at the early stage of operation, enforcing dynamic mode switching may result in unstable or suboptimal behavior. The warm-up phase ensures safe and consistent operation by relying solely on the rule-based control mode 205, while allowing the system to build up the historical and estimated cost values necessary for informed decision-making in later stages.

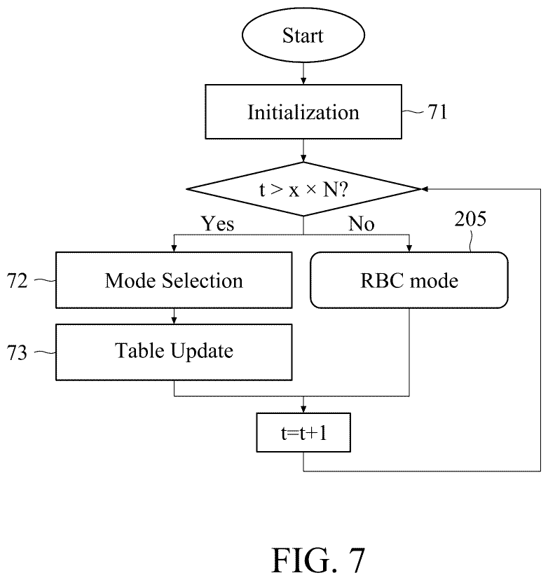

FIG. 7 is a flow diagram illustrating the overall process of dynamic mode selection, according to an embodiment of the present disclosure. As shown in FIG. 7, the process begins with an Initialization stage 71, during which the system initializes internal variables, parameters, and data structures, including the cost evaluation table 202. In particular, the Q-values stored in the cost evaluation table 202 are initially set to zero for all control modes and time intervals. This initialization allows the system to begin accumulating meaningful cost evaluations from scratch, without being biased by arbitrary prior values.

Subsequently, the system checks whether the current time step t exceeds a threshold defined by x×N, where N is the number of time intervals per day and x is a predetermined multiplier representing the duration of the warm-up phase. If the condition t>x×N is not yet satisfied, the system remains in the rule-based control mode 205 while collecting additional data and populating the cost evaluation table 202.

Once the condition is met, the system transitions to the Mode Selection stage 72, in which the computing device compares cost values from the cost evaluation table 202 and selects the rule-based control mode or the scheduling mode for each interval, depending on which yields lower cost. Thereafter, in the Table Update stage 73, the cost evaluation table 202 is updated using the most recent future cost computations, enabling continual refinement and adaptation of control policy. After each iteration, the time step is incremented, and the cycle repeats, enabling ongoing optimization and learning throughout system operation.

The power management system and method proposed herein provide an adaptive control framework that intelligently switches between a rule-based control mode and a scheduling mode based on a learned cost evaluation table. By leveraging real-time measurement data, forecasted demand and generation, and mode-specific estimation models, the disclosed system dynamically minimizes energy costs while maintaining operational flexibility. This hybrid control strategy not only enhances the efficiency and responsiveness of photovoltaic and energy storage integration, but also offers scalability for deployment in diverse energy management scenarios.

In some embodiments, the system operates over recurring time intervals within a daily cycle. Let N denote the number of time intervals per day, T denote the optimization horizon used for cumulative cost evaluation, H_u denote the update delay horizon with t_u=t−H_u identifying a past index targeted for update, and H_f denote the forecast horizon used by the forecast model to generate predicted demand and photovoltaic generation. These parameters satisfy H_u≥T and H_f≥T so that updates rely on realized data across the evaluation window and forecast coverage spans the same window. A learning rate a E (0,1], as previously described in connection with the weighted-sum update of the cost evaluation table 202, governs the blending of newly computed cumulative costs with previously stored values.

As used herein, a “past period” refers to a contiguous sequence of time intervals over which cost estimation is performed using the first estimation model 505 and the second estimation model 604 (see FIGS. 5A-6B). A “future cost” refers to a cumulative cost value computed for the optimization horizon based on realized or forecasted operating conditions (see FIG. 4). The “cost evaluation table” is a data structure that stores, for each time interval, cost values associated with the rule-based control mode and the scheduling mode and that is updated over time using realized measurement data and forecast coverage, as disclosed with reference to FIGS. 3-6B. For deterministic time-of-day alignment, deriving the time-interval index from a current time value comprises computing a modulo of the current time value with respect to the total count of time intervals per day, as described in FIG. 3.

Correlating H_f with T ensures that cost evaluation uses complete predictive coverage, while setting H_u to at least T ensures that updates reflect actual conditions across the entire evaluation window. The learning-rate blending, as previously noted, balances responsiveness against stability, mitigating oscillatory behavior and improving economic performance. The explicit modulo-based indexing described in FIG. 3 prevents slot drift and guarantees that tariff-sensitive comparisons and updates occur in the intended time-of-day context, thereby improving predictability and simplifying table maintenance under time-of-use pricing. In some embodiments, the computing device 101 defers replacing a stored cost value for a time-interval index corresponding to a previous time value until measurement data used to calculate the corresponding future cost has been collected for each of the subsequent time intervals in the past period; once this condition is satisfied, the replacement is performed using a weighted sum of the corresponding future cost and the stored cost value. Deferring the update until realized data is complete reduces bias from forecast error and telemetry latency, increases the accuracy of subsequent cost comparisons, and enhances robustness under variable load and intermittent renewable generation. Collectively, these features enable cost-aware, adaptive control that remains stable and responsive, improves economic outcomes, protects battery health, and supports reliable operation in environments with dynamic tariffs and uncertain forecasts.

While this disclosure has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power management system, comprising:
an inverter, operatively coupled to a photovoltaic (PV) array, a power grid, and a battery, the inverter configured to operate in one of multiple operating modes to determine a power setpoint for the battery, wherein the operating modes includes a rule-based control mode and a scheduling mode; and
a computing device, in communication with the inverter, the computing device being configured to:
control the inverter to operate in one of the rule-based control mode and the scheduling mode based on a cost evaluation table, wherein the cost evaluation table is configured to store, for each of a plurality of time intervals, a cost value corresponding to each of the operating modes;
collect measurement data periodically from the inverter;
calculate a first future cost corresponding to the rule-based control mode and a second future cost corresponding to the scheduling mode based on the measurement data; and
update the cost evaluation table based on the first future cost and the second future cost.

2. The power management system as claimed in claim 1, wherein the computing device is further configured to:
retrieve, from the cost evaluation table based on a time interval index derived from a current time value, a first current cost corresponding to the rule-based control mode and a second current cost corresponding to the scheduling mode;
compare the first current cost and the second current cost to select one of the rule-based control mode and the scheduling mode as a lower-cost mode;
control the inverter to operate in the selected lower-cost mode; and
update the cost evaluation table by adjusting the first current cost and the second current cost based on the first future cost and the second future cost, respectively.

3. The power management system as claimed in claim 2, wherein the computing device is further configured to:
in response to determining that the second current cost is less than the first current cost, control the inverter to operate in the scheduling mode; and
in response to determining that second current cost is not less than the first current cost, control the inverter to operate in the rule-based control mode.

4. The power management system as claimed in claim 2, wherein the computing device is further configured to:
update the cost evaluation table by replacing the first current cost with a first weighted sum of the first future cost and the first current cost, and replacing the second current cost with a second weighted sum of the second future cost and the second current cost.

5. The power management system as claimed in claim 1, wherein the computing device is further configured to:
apply a first estimation model corresponding to the rule-based control mode, based on the measurement data at a previous time interval in a past period, to calculate a first estimated cost;
for each of subsequent time intervals in the past period:
retrieve, from the cost evaluation table, cost values corresponding to the rule-based control mode and the scheduling mode;
select, by comparing the retrieved cost values, one of the rule-based control mode and the scheduling mode as a lower-cost mode for the subsequent time interval; and
apply an estimation model corresponding to the selected lower-cost mode, based on the measurement data corresponding to the subsequent time interval, to calculate a first subsequent estimated cost;
sum the first estimated cost and the first subsequent estimated costs over the past period to obtain the first future cost;
apply a second estimation model corresponding to the scheduling mode, based on the measurement data corresponding to the previous time interval, to calculate a second estimated cost;
for each of the subsequent time intervals in the past period:
retrieve, from the cost evaluation table, the cost values corresponding to the rule-based control mode and the scheduling mode;
select, by comparing the retrieved cost values, one of the rule-based control mode and the scheduling mode as a lower-cost mode for the subsequent time interval; and
apply the estimation model corresponding to the selected lower-cost mode, based on the measurement data corresponding to the subsequent time interval, to calculate a second subsequent estimated cost; and
sum the second estimated cost and the firsts over the past period to obtain the second future cost.

6. The power management system as claimed in claim 5, wherein the measurement data comprises power demand, power generation of the PV array, and a State of Charge (SOC) of the battery.

7. The power management system as claimed in claim 6, wherein the computing device is further configured to:
in response to applying the first estimation model,
obtain, through the first estimation model, an estimated battery power corresponding to the previous time interval based on the measurement data corresponding to the previous time interval;
calculate the first estimated cost based on a tariff of the power grid, the estimated battery power, and the measurement data, each corresponding to the previous time interval;
for each of the subsequent time intervals in the past period:
in response to applying the first estimation model,
obtain, through the first estimation model, the estimated battery power corresponding to the subsequent time interval based on the measurement data corresponding to the subsequent time interval; and
calculate, a subsequent estimated cost based on the tariff of the power grid, the estimated battery power, and the measurement data, each corresponding to the subsequent time interval.

8. The power management system as claimed in claim 7, wherein the computing device is further configured to:
generate, through a forecast model and based on historical measurement data associated with the power demand and the power generation of the PV array, predicted data associated with the power demand and the power generation of the PV array periodically;
obtain, through the second estimation model, an optimized battery power corresponding to the previous time interval based on the predicted data and the SOC of the battery corresponding to the previous time interval;
calculate the second estimated cost based on a tariff of the power grid, the optimized battery power, and the measurement data, each corresponding to the previous time interval; and
for each of the subsequent time intervals in the past period:
in response to applying the second estimation model,
obtain, through the second estimation model, the optimized battery power corresponding to the subsequent time interval based on the predicted data and the SOC of the battery corresponding to the subsequent time interval; and
calculate the subsequent estimated cost based on the tariff of the power grid, the optimized battery power, and the measurement data, each corresponding to the subsequent time interval.

9. The power management system as claimed in claim 8, wherein the inverter is further configured to:
in the scheduling mode, determine the power setpoint for the battery through an optimization model based on the predicted data, the SOC of the battery, and the tariff; and
in the rule-based control mode, determine the power setpoint for the battery based on the measurement data.

10. The power management system as claimed in claim 1, wherein the computing device controls the inverter to operate in the rule-based control mode during an initial operating period prior to selection of the operating mode based on the cost evaluation table.

11. The power management system as claimed in claim 1, further comprising:
an edge device, interface between the inverter and the computing device to relay real-time measurement data and control signals, wherein the computing device is a cloud server.

12. The power management system as claimed in claim 1, wherein the inverter is configured to adjust a power flow more frequently in the rule-based control mode than in the scheduling mode.

13. The power management system of claim 2, wherein deriving the time interval index from the current time value comprises computing a modulo of the current time value with respect to a total count of the plurality of time intervals per day.

14. The power management system of claim 5, wherein updating the cost evaluation table comprises replacing a stored cost value for a time interval index corresponding to a previous time value only after measurement data used to calculate the corresponding future cost has been collected for each of the subsequent time intervals in the past period, the replacement being performed using a weighted sum of the corresponding future cost and the stored cost value.

15. A power management method, executed by a computing device in communication with an inverter, the method comprising:
controlling the inverter to operate in one of a rule-based control mode and a scheduling mode based on a cost evaluation table, wherein the inverter is operatively coupled to a photovoltaic (PV) array, a power grid, and a battery, and the inverter is configured to operate in one of multiple operating modes to determine a power setpoint for the battery, wherein the operating modes includes the rule-based control mode and the scheduling mode, and wherein the cost evaluation table is configured to store, for each of a plurality of time intervals, a cost value corresponding to each of the operating modes;
collecting measurement data periodically from the inverter;
calculating a first future cost corresponding to the rule-based control mode and a second future cost corresponding to the scheduling mode based on the measurement data; and
updating the cost evaluation table based on the first future cost and the second future cost.

16. The power management method as claimed in claim 15, further comprising:
retrieving, from the cost evaluation table based on a time interval index derived from a current time value, a first current cost corresponding to the rule-based control mode and a second current cost corresponding to the scheduling mode;
comparing the first current cost and the second current cost to select one of the rule-based control mode and the scheduling mode as a lower-cost mode;
controlling the inverter to operate in the selected lower-cost mode; and
updating the cost evaluation table by adjusting the first current cost and the second current cost based on the first future cost and the second future cost, respectively.

17. The power management method as claimed in claim 16, further comprising:
in response to determining that the second current cost is less than the first current cost, controlling the inverter to operate in the scheduling mode; and
in response to determining that second current cost is not less than the first current cost, controlling the inverter to operate in the rule-based control mode.

18. The power management method as claimed in claim 16, further comprising:
updating the cost evaluation table by replacing the first current cost with a first weighted sum of the first future cost and the first current cost, and replacing the second current cost with a second weighted sum of the second future cost and the second current cost.

19. The power management method as claimed in claim 15, further comprising:
applying a first estimation model corresponding to the rule-based control mode, based on the measurement data at a previous time interval in a past period, to calculate a first estimated cost at the previous time interval;
for each of subsequent time intervals in the past periods;
retrieving, from the cost evaluation table, cost values corresponding to the rule-based control mode and the scheduling mode;
selecting, by comparing the retrieved cost values, one of the rule-based control mode and the scheduling mode as a lower-cost mode for the subsequent time interval; and
applying an estimation model corresponding to the selected lower-cost mode, based on the measurement data corresponding to the subsequent time interval, to calculate a first subsequent estimated cost;
summing the first estimated cost and the first subsequent estimated costs over the past period to obtain the first future cost;
applying a second estimation model corresponding to the scheduling mode, based on the measurement data corresponding to the previous time interval, to calculate a second estimated cost;
for each of the subsequent time intervals in the past period:
retrieving, from the cost evaluation table, the cost values corresponding to the rule-based control mode and the scheduling mode;
selecting, by comparing the retrieved cost values, one of the rule-based control mode and the scheduling mode as a lower-cost mode for the subsequent time interval; and
applying the estimation model corresponding to the selected lower-cost mode, based on the measurement data corresponding to the subsequent time interval, to calculate a second subsequent estimated cost; and
summing the second estimated cost and the second subsequent estimated costs over the past period to obtain the second future cost.

20. The power management method as claimed in claim 19, wherein the measurement data comprises power demand, power generation of the PV array, and a State of Charge (SOC) of the battery.

21. The power management method as claimed in claim 20, further comprising:
in response to applying the first estimation model,
obtaining, through the first estimation model, an estimated battery power corresponding to the previous time interval based on the measurement data corresponding to the previous time interval;
calculating the first estimated cost based on a tariff of the power grid, the estimated battery power, and the measurement data, each corresponding to the previous time interval;
for each of the subsequent time intervals in the past period:
in response to applying the first estimation model,
obtaining, through the first estimation model, the estimated battery power corresponding to the subsequent time interval based on the measurement data corresponding to the subsequent time interval; and
calculating, a subsequent estimated cost based on the tariff of the power grid, the estimated battery power, and the measurement data, each corresponding to the subsequent time interval.

22. The power management method as claimed in claim 21, further comprising:
generating, through a forecast model and based on historical measurement data associated with the power demand and the power generation of the PV array, predicted data associated with the power demand and the power generation of the PV array periodically;
obtaining, through the second estimation model, the estimated battery power corresponding to the previous time interval based on the predicted data and the SOC of the battery corresponding to the previous time interval;
calculating the second estimated cost based on a tariff of the power grid, the estimated battery power, and the measurement data, each corresponding to the previous time interval; and
for each of the subsequent time intervals in the past period:
in response to applying the second estimation model,
obtaining, through the second estimation model, the estimated battery power corresponding to the subsequent time interval based on the predicted data and the SOC of the battery corresponding to the subsequent time interval; and
calculating the subsequent estimated cost based on the tariff of the power grid, the optimized battery power, and the measurement data, each corresponding to the subsequent time interval.

23. The power management method as claimed in claim 16, further comprising:
deriving the time interval index from the current time value by computing a modulo of the current time value with respect to a total count of the plurality of time intervals per day.

24. The power management method as claimed in claim 19, further comprising:
updating the cost evaluation table by replacing a stored cost value for a time interval index corresponding to a previous time value only after measurement data used to calculate the corresponding future cost has been collected for each of the subsequent time intervals in the past period, the replacement being performed using a weighted sum of the corresponding future cost and the stored cost value.
